(19) United States
(12) Patent Application Publication
(10) Pub. No.: US 2013/0269236 A1
(43) Pub. Date: Oct. 17, 2013

(54) FISHING DEVICE

(71) Applicant: Vladimir Oblonskij, Brooklyn, NY (US)

(72) Inventor: Vladimir Oblonskij, Brooklyn, NY (US)

(21) Appl. No.: 13/448,622

(22) Filed: Apr. 17, 2012

(51) Int. Cl. A01K 85/02; A01K 85/00; A01K 91/04

(52) U.S. Cl. 43/42.36; 43/43.16; 43/42.41

(57) ABSTRACT

A fishing device has a hook unit attachable to a fishing rod and including a first end provided with a connecting member, an elongated carrying element extending from the connecting member to a second end, a hook at the second end and extending from the carrying element back toward the first end, a load arranged on the carrying element between the first and second ends, a plate at the first end, and a lure piece mounted on the hook unit and having an end portion extending beyond the hook unit and having a thin tail shape movable transversely to the hook unit in all directions.

### BACKGROUND OF THE INVENTION

The present invention relates to fishing devices.

More particularly, it relates to fishing devices, including a hook part attachable to a fishing rod, and a lure associated with the hook.

Fishing devices of this type are well known and widely used in many varieties. It is believed that the existing fishing devices of this type can be further improved.

### SUMMARY OF THE INVENTION

Accordingly, it is an object of the present invention to provide fishing devices, which is a further improvement of the existing fishing devices.

In keeping with these objects and with others which will become apparent hereinafter, one feature of the present invention resides, briefly stated, in a fishing device, comprising a hook unit attachable to a fishing rod and the like, said hook unit including a first end provided with a connecting member for connecting to the fishing rod and the like, an elongated carrying element extending from said connecting member to a second end, a hook formed at said second end of said hook unit and extending arcuately from said elongated carrying element back in a direction toward said first end, a load arranged on said elongated carrying element between said first end and said second end, a plate arranged at said first end on said elongated connecting element and extending transversely to the latter; and a lure piece mounted on said hook unit, said lure piece having an end portion extending beyond said hook unit and having a thin tail shape so that said end portion is movable transversely to said hook unit in all directions

In accordance with another feature of the present invention said lure piece is composed of a plastic material, with said end portion being of one piece with a remaining portion of said lure piece.

Still another feature of the present invention is that said lure piece has a main portion extending inside between said connecting member and said hook, said end portion of said lure piece being located outside of said hook.

A further feature of the present invention is that said main said main portion of said lure piece is mounted on said connecting member and said hook, and also said main portion of said lure piece has a thickness which is greater than the thickness of said end portion of said lure piece, said lure piece also having a transitional portion located between said main portion and said end portion and having a thickness which reduces from the thickness of said main portion to the thickness of said end portion of said lure piece.

When the fishing device is designed in accordance with the present invention it has a very high degree of attractiveness for fish and improves fishing results.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a side view of a fishing device in accordance with the present invention; and

FIG. 2 is a top view of the inventive fishing device in accordance with the present invention.

### DESCRIPTION OF THE PREFERRED EMBODIMENTS

A fishing device in accordance with the present invention is attachable to an equipment held by a user, a vessel, etc., such as for example to a fishing rod.

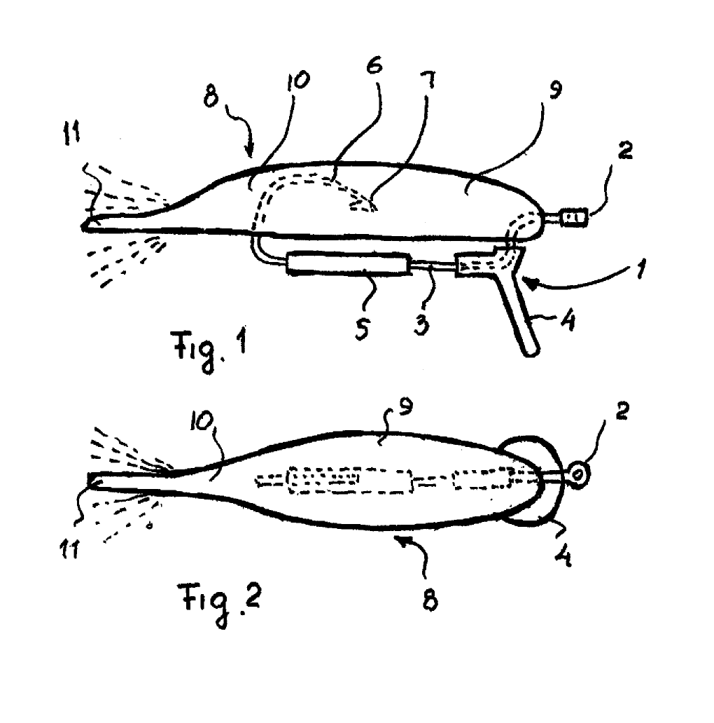

The inventive device has a hook part which is identified as a whole with reference numeral 1. The hook part 1 includes a first end (a left end in FIGS. 1 and 2) provided with a connecting member 2 which can be formed as a loop or the like formed at an end of an elongated carrying element 3.

The elongated carrying element 3 extends through a throughgoing opening of a part of a plate 4, and thereby supports the plate 4, which provides an additional play of the hook part when it is moved in water.

A load 5 is further carried by the elongated carrying element 3 between its ends and can be adjusted to various positions between said ends. An opposite end of the elongated carrying element 3 is provided with a hook 6 which curves back to the first end and has a sharp, spear-shaped tip 7, as known in the art.

The inventive fishing device is further provided with a lure piece, which is identified as a whole with reference numeral 8. The lure piece is mounted forwardly on the connecting member 2, on its part extending from the loop, and rearwardly on the hook 6. The lure piece 8 is composed of a soft, polymeric material of a gel-like softness for example silicone. At the left end side it can have a small channel, through which the loop and the part extending from it of the connecting member 2 can pass, while at the right end side the hook 6 pierces through the lure piece 8 and it is fully embedded in and covered by the latter.

The lure piece 8 has a main portion 9 located between the connecting member 2 and the hook 6, an intermediate portion 10, and an end portion 11. The end portion 11 has a thickness which is significantly smaller than a thickness of the main portion 9, which the intermediate portion 10 has a thickness which reduces from the thickness of the main portion 9 to the thickness of the end portion 11.

The end portion 10 and at least a part of the intermediate portion of the lure piece 8 are located rearwardly outside of the hook 6. The end portion 11 of the lure piece 8 is very thin, substantially strip-shaped and tail-shaped, and composed of the above-mentioned gel-like polymeric material, for example silicone.

During movement of the fishing device in water, the end portion of the lure piece moves or “wobbles” transversely to the elongated carrying element 3 in all direction, as shown in FIGS. 1 and 2 by dash lines. The attractiveness of the lure piece 8 for fish is significantly increased.

It will be understood that each of the elements described above, or two or more together, may also find a useful application in other types of constructions differing from the type described above.

While the invention has been illustrated and described as embodied in fishing devices, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A fishing device, comprising a hook unit attachable to a fishing rod and the like, said hook unit including a first end provided with a connecting member for connecting to the fishing rod and the like, an elongated carrying element extending from said connecting member to a second end, a hook formed at said second end of said hook unit and extending arcuately from said elongated carrying element back in a direction toward said first end, a load arranged on said elongated carrying element between said first end and said second end, a plate arranged at said first end on said elongated connecting element and extending transversely to the latter; and a lure piece mounted on said hook unit, said lure piece having an end portion extending beyond said hook unit and having a thin tail shape so that said end portion is movable transversely to said hook unit in all directions.

2. A fishing device as defined in claim 1, wherein said plate has a throughgoing opening, through which said elongated connecting element extends to support said plate.

3. A fishing device as defined in claim 1, wherein said lure piece is composed of a plastic material, with said end portion being of one piece with a remaining portion of said lure piece.

4. A fishing device as defined in claim 1, wherein said lure piece has a main portion extending inside between said connecting member and said hook, said end portion of said lure piece being located outside of said hook.

5. A fishing device as defined in claim 4, wherein said main portion of said lure piece is mounted on said connecting member and said hook.

6. A fishing device as defined in claim 4, wherein said main portion of said lure piece has a thickness which is greater than the thickness of said end portion of said lure piece, said lure piece also having a transitional portion located between said main portion and said end portion and having a thickness which reduces from the thickness of said main portion to the thickness of said end portion of said lure piece.

7. A fishing device as defined in claim 1, wherein said hook is fully embedded in and covered by said lure piece.
